(19) United States
(12) Patent Application Publication
(10) Pub. No.: US 2004/0267734 A1
(43) Pub. Date: Dec. 30, 2004

(54) Document search method and apparatus

(75) Inventor: Eiichiro Toshima, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/847,916

(22) Filed: May 19, 2004

(30) Foreign Application Priority Data
May 23, 2003 (JP) 2003-146776

(51) Int. Cl. G06F 17/30

(52) U.S. Cl. 707/3

(57) ABSTRACT

In a document search method for searching for a document, a character recognition process is applied to an image of a search image, and text data which is estimated to be correctly recognized is extracted from the text data obtained by the character recognition process. Text feature information is generated based on the extracted text data, and a plurality of documents are searched for a document corresponding to the search document using the generated text feature information as a query.

### FIELD OF THE INVENTION

The present invention relates to a document search apparatus for searching for digital document data to be handled by a computer, a document search method, and a recording medium.

### BACKGROUND OF THE INVENTION

In recent years, along with the prevalence of personal computers (PCs), it is a common practice to create documents using application software (document creation software and the like) on a PC. More specifically, various documents and the like can be created, edited, copied, searched, and so forth on the screen of the PC.

Also, along with the development and spread of networks, digital document data created on PCs are often distributed intact in place of paper documents output using printers and the like. That is, since such digital document data is accessed from another PC or the like or is transmitted or distributed as an e-mail message or the like, a digital document is handled as data, and a paperless document creation environment is progressing.

Such digital document data are very effective in information size reduction, easy access by associating documents, sharing of information by a large number of users, and the like since they are systematically managed by computers by building a document management system. On the other hand, paper documents also have large merits in legibility, handiness, convenience upon carrying, intuitive understandability, and the like compared to digital document data. For this reason, even when digital document data are created, it is often efficient to output digital document data as paper documents using a printer apparatus or the like upon use. Hence, under the present situation, paper and digital documents achieve a complementary relationship and are distributed in combination.

Since paper documents are very convenient for the user to refer to, they are distributed in various occasions. The user often wants to not only refer to documents but also to re-edit/re-use them. In such case, the user must edit a digital document data file by separately acquiring it, thus disturbing re-usability of documents.

In order to solve such isolation problem between paper and digital documents, a search method that scans a printed paper document, and searches for original digital document data as a print source of that paper document on the basis of that information (scan data) has been proposed. Such search method is called a master copy search. A practical method of the master copy search is proposed by, e.g., Japanese Patent Laid-Open Nos. 2001-025656 and 3-263512. Also, Japanese Patent Laid-Open No. 2001-022773 describes a document analysis technique for a keyword search.

For example, Japanese Patent Laid-Open No. 2001-025656 has proposed a method for checking similarity between the feature amounts extracted from raster image data of a paper document, and those extracted from raster image data obtained by rasterizing digital document data in advance, to search for original document data. In this proposal, since documents are compared based on images, strict invariance to some extent is required when an application generates a raster image. However, it is often difficult for a practical system (application) to generate a raster image by strictly matching layouts. Previously, when the version of an application or OS has changed, a layout often changes more or less. In this manner, since layout invariance is not guaranteed, an original document cannot be detected even if the contents remain the same.

For example, Japanese Patent Laid-Open No. 3-263512 has proposed a method which converts a document printed on print sheets into digital data by scanning it using a scanner, applies a character recognition process to the scanned data, prompts the user to designate a characteristic character string from those obtained by the character recognition process as a search range, and searches for a document whose contents and positional relationship match with the obtained search range. However, in this proposal, the user must designate a character string from a document which has been scanned and undergone the character recognition process, and the burden, i.e., designation of a search range, remains unremoved. Not only the user must designate a search range, but also a range that can be designated is often not available, since the character recognition results normally include some recognition errors. In order to avoid any recognition errors in consideration of such situation, fuzzy matching is normally adopted. However, if a broad range to be designated as a query is set, a considerably heavy processing load is imposed on comparison; if a narrow range is set, many unwanted search results are included, resulting in poor accuracy. Hence, neither cases are practical. That is, in order to conduct a search using, as a query, text obtained by applying the character recognition process to a paper document, a device of the next level that cannot be solved by a simple matching process is required.

Japanese Patent Laid-Open No. 2001-022773 describes that characters which have certainty levels of character recognition equal to or lower than a predetermined value are determined as false recognition characters, and a character string including false recognition characters at a predetermined ratio is not used as a keyword upon extracting and assigning a keyword from an image document. However, Japanese Patent Laid-Open No. 2001-022773 describes only keyword assignment for a so-called keyword search, but does not support a master copy search.

### SUMMARY OF THE INVENTION

The present invention has been made in consideration of the above problems, and has as its object to obviate the need for troublesome processes such as designation of a search range and the like, and to implement a master copy search with high accuracy within a practical response time.

In order to achieve the above object, a document search method according to the present invention comprises: a character recognition step of executing a character recognition process for an image of a search document; an extraction step of extracting text data which is estimated to be correctly recognized from text data obtained in the character recognition step; a generation step of generating text feature information on the basis of the text data extracted in the extraction step; and a search step of searching a plurality of documents for a document corresponding to the search document using the text feature information generated in the generation step as a query.

In order to achieve the above object, a document search apparatus according to the present invention comprises: a character recognition unit configured to execute a character recognition process for an image of a search document; an extraction unit configured to extract text data which is estimated to be correctly recognized from text data obtained in the character recognition unit; a generation unit configured to generate text feature information on the basis of the text data extracted in the extraction unit; and a search unit configured to search a plurality of documents for a document corresponding to the search document using the text feature information generated by the generation unit as a query.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the overall arrangement of a document search apparatus according to an embodiment of the present invention;

FIG. 2 shows an example of block analysis;

FIG. 3 shows an example of OCR text extraction and false recognition removal;

FIG. 4 shows the configuration of a layout similarity search index in the document search apparatus of the embodiment;

FIG. 5 shows the configuration of a text content similarity search index in the document search apparatus of the embodiment;

FIG. 6 shows the configuration of a word importance table in the document search apparatus of the embodiment;

FIG. 7 is a flowchart showing an example of the processing sequence of the document search apparatus of the embodiment;

FIG. 8 is a flowchart showing an example of the processing sequence of a document registration process;

FIG. 9 is a flowchart showing an example of the processing sequence of a master copy search execution process; FIG. 10 is a flowchart showing an example of the processing sequence of text content information extraction;

FIG. 11 shows an example of OCR text extraction and false recognition character removal according to the second embodiment;

FIG. 12 is a flowchart showing another example of the processing sequence of text content information extraction according to the second embodiment;

FIG. 13 shows an example of false recognition removal by recognition assistance;

FIG. 14 shows an example of false recognition removal based on OCR likelihood;

FIG. 15 is a block diagram showing the overall arrangement of a document search apparatus according to the fourth embodiment;

FIG. 16 shows the configuration of a text content similarity search index in case of false recognition removal based on OCR likelihood;

FIG. 17 is a flow chart showing an example of a document registration process in case of false recognition removal based on OCR likelihood; and

FIG. 18 is a flowchart showing another example of the processing sequence of text content information extraction in case of false recognition removal based on OCR likelihood.

### DETAILED DESCRIPTION OF THE PREFERRED EMBODIMENTS

Preferred embodiments of the present invention will now be described in detail in accordance with the accompanying drawings.

### First Embodiment

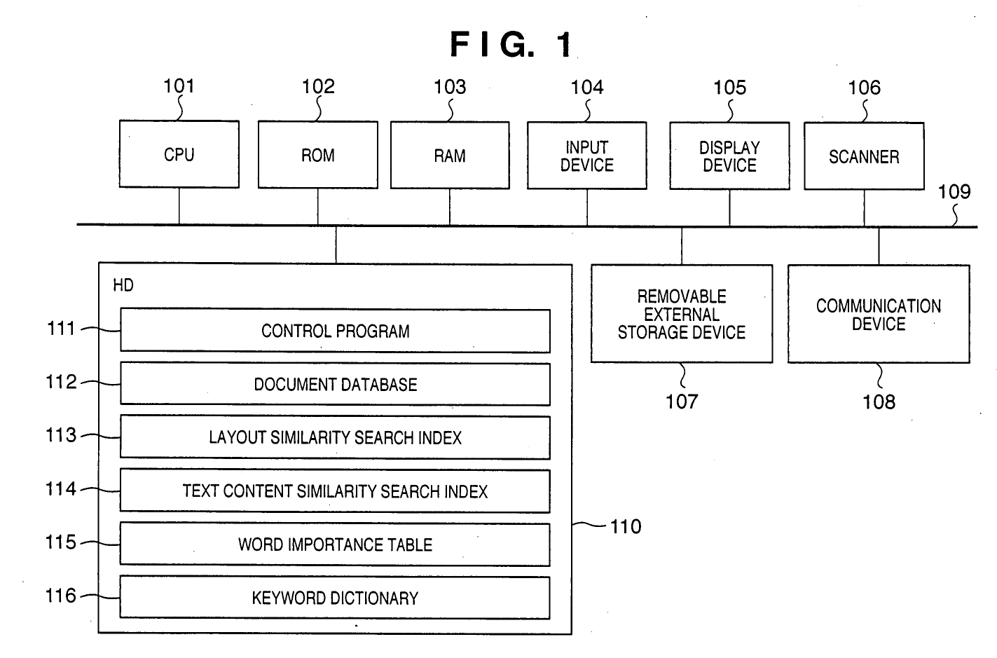

FIG. 1 is a block diagram showing the arrangement of a document search apparatus according to this embodiment. In the arrangement shown in FIG. 1, reference numeral 101 denotes a microprocessor (CPU), which makes arithmetic operations, logical decisions, and the like for a document search process, and controls respective building components connected to a bus 109. The bus (BUS) 109 transfers address signals and control signals that designate the building components to be controlled by the CPU 101. Also, the bus 109 transfers data among the respective building components.

Reference numeral 103 denotes a rewritable random-access memory (RAM), which is used as a temporary storage or the like of various data from the respective building components. Reference numeral 102 denotes a read-only memory (ROM) which stores a boot program and the like to be executed by the CPU 101. Note that the boot program loads a control program 111 stored in a hard disk 110 onto the RAM 103, and makes the CPU 101 execute it upon launching a system. The control program 111 will be described in detail later with reference to the flowcharts.

Reference numeral 104 denotes an input device, which includes a keyboard and pointing device (a mouse or the like in this embodiment). Reference numeral 105 denotes a display device, which comprises, e.g., a CRT, liquid crystal display, or the like. The display device 105 makes various kinds of display under the display control of the CPU 101. Reference numeral 106 denotes a scanner which optically scans a paper document, and converts it into digital document.

The hard disk (HD) 110 stores the control program 111 to be executed by the CPU 101, a document database 112 which stores documents that are to undergo a search process and the like, a layout search index 113 used as an index upon conducting a layout similarity search, a text content similarity index 114 used as an index upon conducting a text content similarity search, a word importance table 115 which stores data associated with importance levels of respective words used upon conducting a text content similarity search, a keyword dictionary 116, and the like.

Reference numeral 107 denotes a removable external storage device, which is a drive used to access an external storage such as a flexible disk, CD, DVD, and the like. The removable external storage device 107 can be used in the same manner as the hard disk 110, and can exchange data with another document processing apparatus via-such recording media. Note that the control program stored in the hard disk 110 can be copied from such external storage device to the hard disk 110 as needed. Reference numeral 108 denotes a communication device, which comprises a network controller in this embodiment. The communication device 108 exchanges data with an external apparatus via a communication line.

In the document search apparatus of this embodiment with the above arrangement, corresponding processes are activated in response to various inputs from the input device 104. That is, when an input signal is supplied from the input device 104, an interrupt signal is sent to the CPU 101. In response to this signal, the CPU 101 reads out various commands stored in the RAM 103, and executes them to implement various kinds of control.

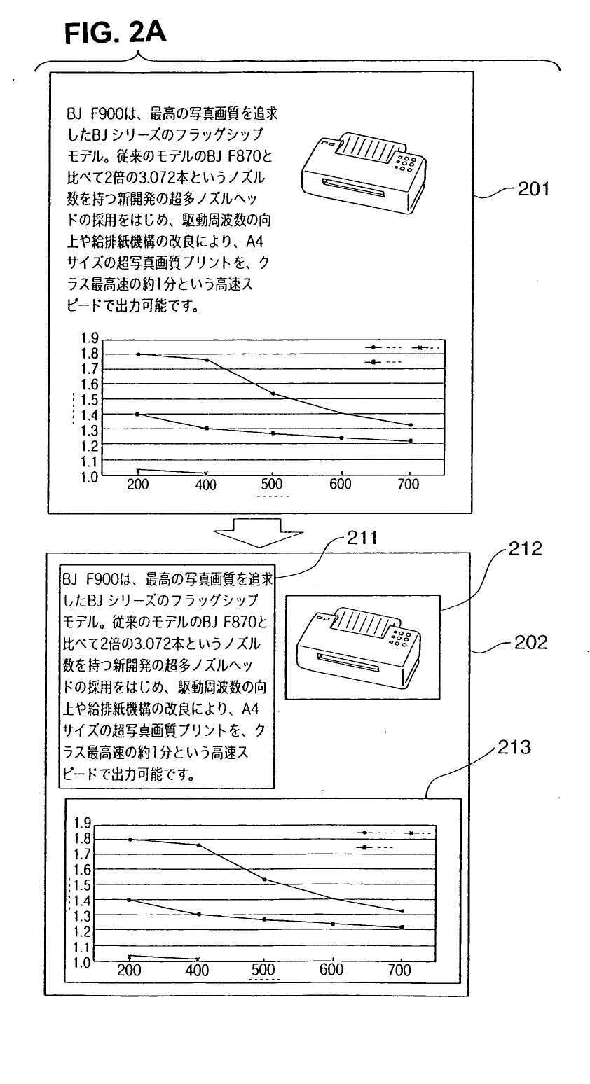

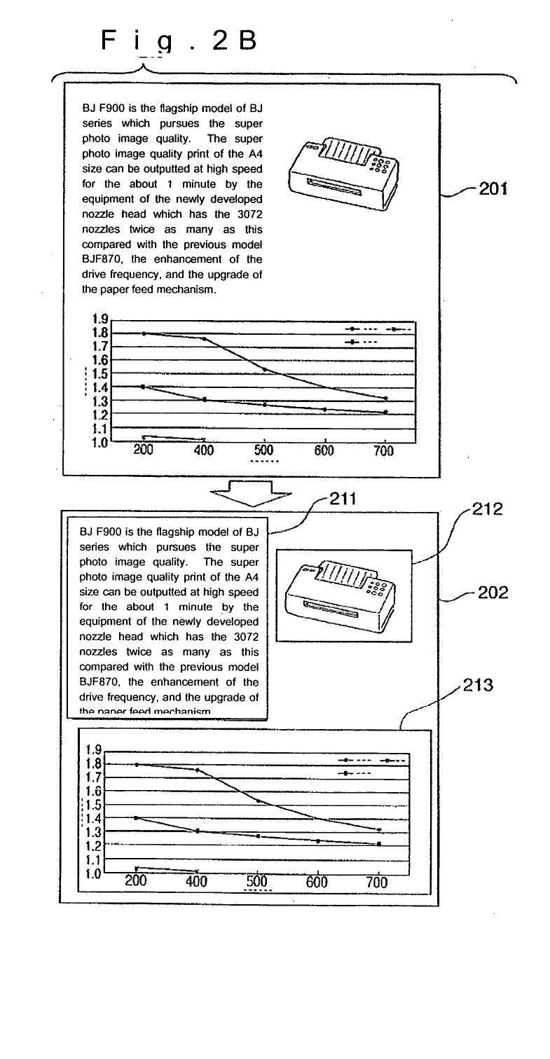

FIG. 2 is a view for explaining block analysis executed in this embodiment. A scan image 201 is a document image which is obtained by scanning a paper document by the scanner 106 as digital data. Block analysis is a technique for dividing the document image into rectangular blocks according to properties. In case of FIG. 2, the document image is divided into three blocks by applying block analysis. One block is a text block 211 including text, and the remaining two blocks are image blocks 212 and 213 since they include information (a grapp, photo, and the like) other than text. Character recognition is applied to the text block 211 to extract text, but no text information is extracted from the image blocks 212 and 213.

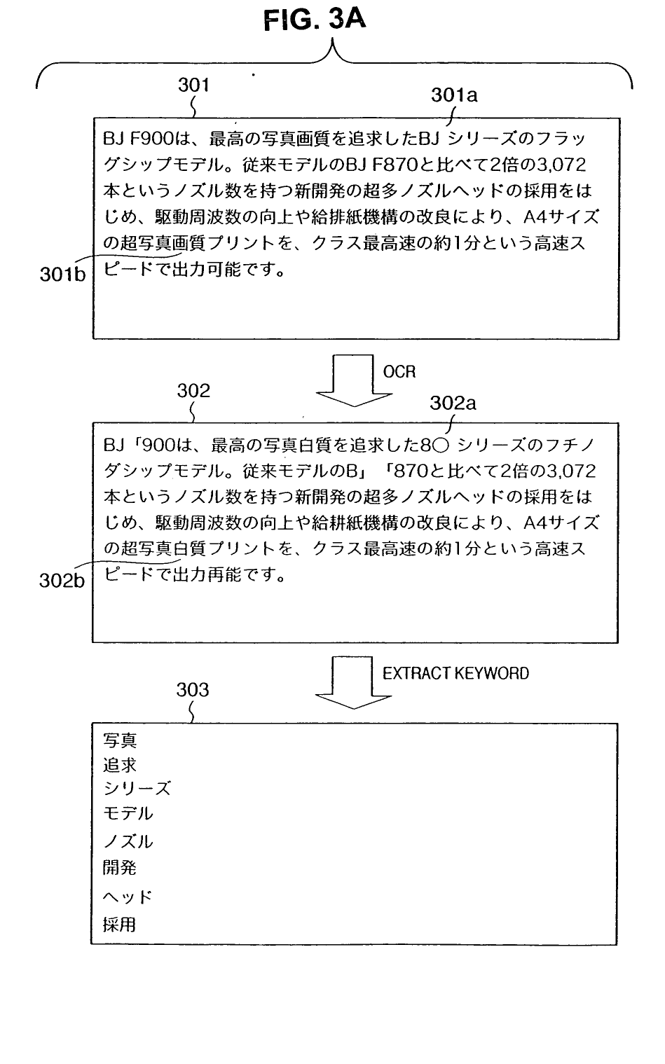

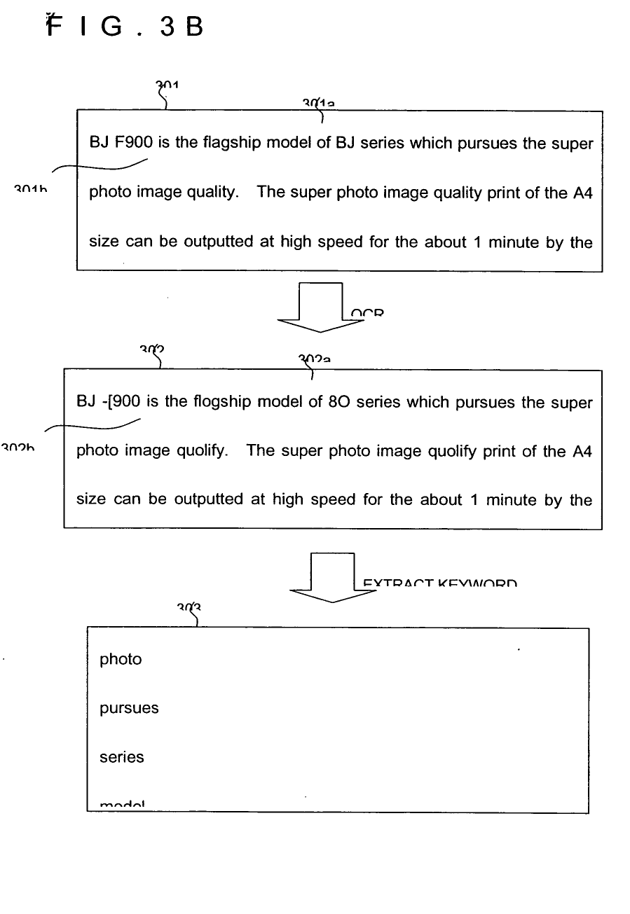

FIG. 3 is a view for explaining OCR text information extracted from the text block, and keyword data which are extracted from the OCR text data by keyword extraction, and from which false recognition data are removed.

A character recognition process is applied to a text block 301 of a scan image to extract text data as OCR text information 302. Since the character recognition process cannot assure 100% accurate recognition, the OCR text information 302 includes false recognition data. In FIG. 3, a character string “BJ [symbol] ” (301a) is recognized as “8 [symbol] ” (301b), and a character string “ [symbol] ” (302a) is recognized as “ [symbol] ” (302b). A master copy search must check matching between such false recognition character strings and correct character string in a master copy. Hence, matching cannot be checked by a simple matching method or the processing load increases too much if it does.

In this embodiment, false recognition data are removed from the OCR text information 302. FIG. 3 shows an example of false recognition removal based on keyword extraction. In this embodiment, a list of analyzable keywords (keyword dictionary 116) is prepared in advance, and keywords included in the OCR text information 302 are listed up as keyword data 303 with reference to this keyword list. Since only keywords included in the keyword dictionary 116 are listed up, unknown words are excluded, and most of false recognition data are removed in this stage. Note that the keyword dictionary 116 is registered with only words of specific parts of speech (in this embodiment, noun, proper noun, and verbal noun) so as to allow easy recognition of document features. In the example shown in FIG. 3, “ [symbol] ”, “ [symbol] ”, and the like are picked up, and “ [symbol] ”, “ [symbol] ”, and the like, which are not included in the keyword dictionary 116, are excluded.

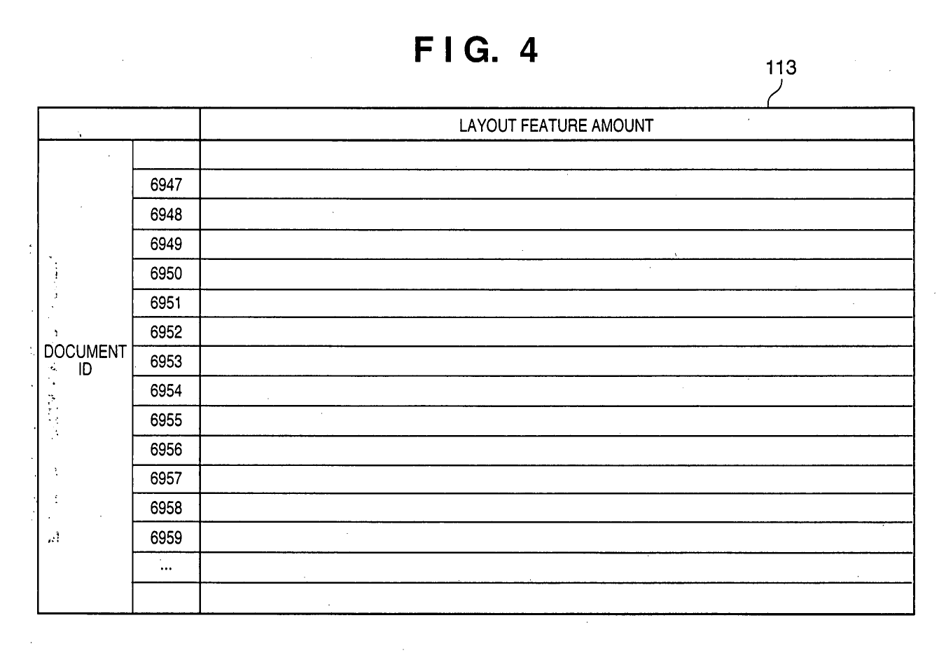

FIG. 4 shows an example of the configuration of a layout similarity search index. A layout similarity search index 113 is index information used upon conducting a similarity search based on a layout. This index stores layout feature amounts in correspondence with documents (identified by unique document IDs) registered in a document database. The layout feature amount is information used to determine layout similarity. For example, the layout feature amounts include image feature amounts that store average luminance information and color information of each rectangle which is obtained by dividing a bitmap image that is formed by printing a document into n (vertical) x m (horizontal) rectangles. As an example of such image feature amounts used to conduct a similarity search, those which are proposed by, e.g., Japanese Patent Laid-Open No. 10-260983 may be used. Note that the positions/sizes of text and image blocks obtained by block analysis above may also be used as the layout feature amounts.

The layout feature amount of a digital document is generated on the basis of bitmap image data of a document, which is formed by executing a pseudo print process upon registration of the document. On the other hand, the layout feature amount of a scanned document is generated based on a scan image which is scanned as digital data. Upon conducting a layout similarity search, the layout feature amount is generated based on a scanned document, and a layout similarity level is calculated for each of the layout feature amounts of respective documents stored in this layout similarity search index 113.

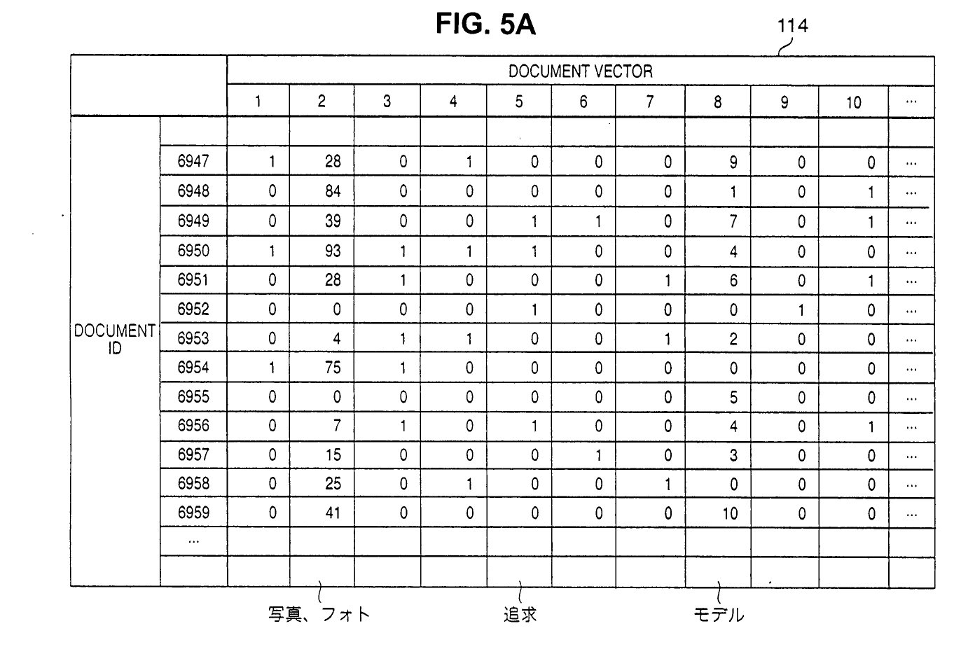

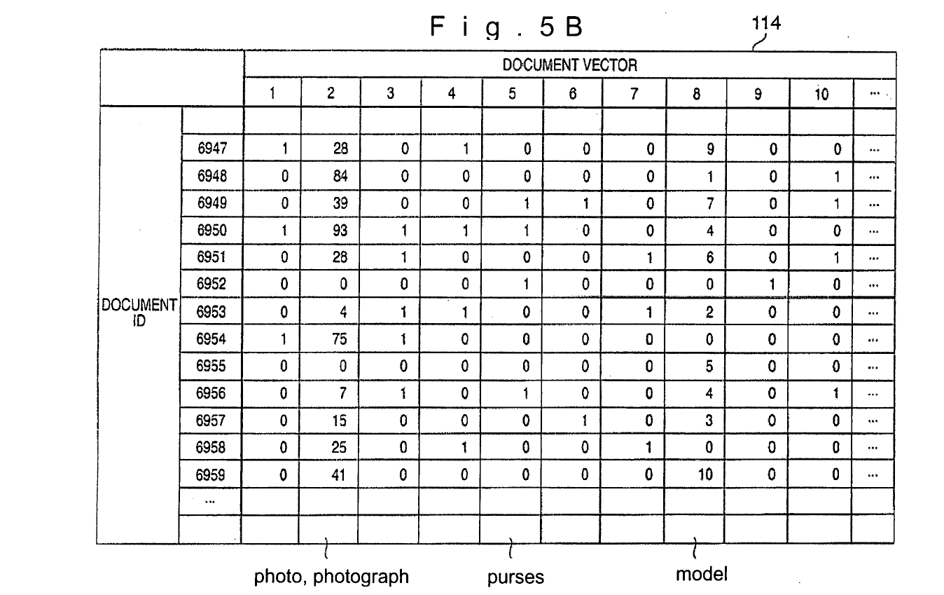

FIG. 5 shows an example of the configuration of a text content similarity search index. A text content similarity search index 114 is index information used to conduct a similarity search based on the similarity of the text contents. This index stores document vectors in correspondence with respective documents registered in the document database. Each document vector is information used to determine the similarity of the text contents. In this case, dimensions of the document vector are defined by words, and the value of each dimension of the document vector is defined by the frequency of occurrence of that word. In the first embodiment, since the extracted keyword data 303 are used, words registered in the text content similarity search index 114 are those which are registered in the keyword dictionary 116. Note that the document vector is formed by defining one dimension using identical or similar word groups in place of accurately using one word per one dimension. For example, in FIG. 5, two words “ [symbol] ” and “ [symbol] ” correspond to dimension 2. The frequency of occurrence of each word or word set included in the document is stored.

When one document includes a plurality of text blocks, all pieces of OCR text information extracted from a plurality of text blocks are combined to generate one document vector.

Upon conducting a master copy search, vector data (query vector) with the same format as the document vectors stored in this index is also generated from a scanned document as a search query, and a text content similarity level is calculated for each of the document vectors of respective documents.

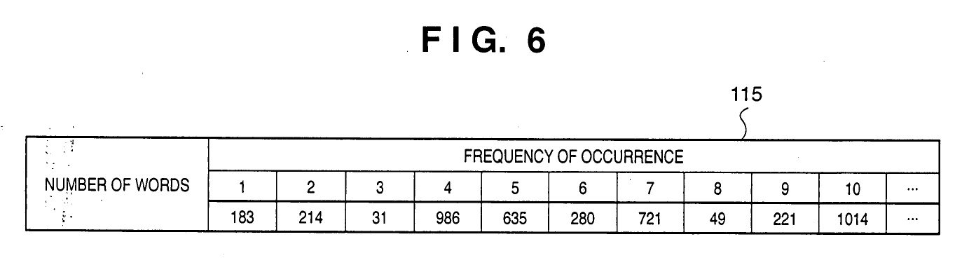

FIG. 6 shows an example of the configuration of a word importance table. A word importance table 115 indicates the importance level of each word upon determining the text content similarity. This table stores the frequency of occurrence of each word in the whole document database.

An importance level Wₖ of each word is calculated as the reciprocal of the frequency of occurrence stored in the work importance table 115. That is, Wₖ is given by:

Wₖ₌1/(frequency of occurrence of word k in whole document database) (1)

If the frequency of occurrence is zero, the importance level of that word is also zero. This is because a word which does not appear in the document database has no use for similarity determination. The reason why the reciprocal of the frequency of occurrence is calculated as the importance level is that ordinary words which frequently appear in many documents have relatively low importance levels upon determining the text content similarity.

The similarity calculation upon determining document similarity in this embodiment will be described below. Let X (X=(x₁, x₂, X₃, . . . xₙ)) be a document vector, Q (Q=(q₁, q₂, q₃, . . . qₙ)) be a query vector, and wk be the importance level of word k. Then, text content similarity TS(X, Q) is given by:

$$TS ( X , Q ) = - {\sum }_{k = 1}^{n} A BS ( {x}_{k} - {q}_{k} ) \times {w}_{k} \qquad ( 2 )$$

That is, the text content similarity TS(X, Q) is expressed by a minus value of an integral obtained by integrating the products calculated by multiplying the absolute values of differences between the frequencies of occurrence of all words (i.e., all dimensions (k=1 to k=n) of the document vector in the text content similarity search index 114) by the importance levels of those words. The reason why the minus value is used is that the text content similarity lowers with increasing difference between the frequencies of occurrence. A higher similarity level is determined with increasing text content similarity value. As for layout similarity, a higher similarity level is set with increasing similarity value.

Total similarity S is basically calculated by adding the text content similarity TS and layout similarity LS, and they are multiplied by weights α and β in accordance with the importance levels of the similarity calculations before they are added. That is, the total similarity S is calculated by:

S=α×TS+β×LS (3)

where α is the weight for text content information, and β is that for the layout information. The values a and β are variable, and the weight α is set to have a smaller value when the reliability of text content information (e.g., the reliability can be evaluated based on whether or not a text block of a document includes a sufficient size of text or whether or not character recognition of text is successful (evaluation of accuracy of character recognition)) is low. For example, when the reliability of text content information is sufficiently high, α=1 and β=1; when the text contents are not reliable, α=0.1 and β=1. As for the layout information, since every documents have layouts, and their analysis results do not impair largely, the reliability of information itself does not largely vary. Hence, in this embodiment, a constant weight β is used.

Note that evaluation of the reliability (accuracy of character recognition) of the text content information may use language analysis such as morphological analysis or the like. At this time, accuracy evaluation can be made by calculating information that can be used to determine whether or not language analysis is normally done (e.g., analysis error ratio). As one embodiment of the analysis error ratio, a value calculated based on the ratio of unknown words (words which are not registered in the dictionary) that have occurred as a result of analysis with respect to the total number of words may be used. As another method, the analysis error ratio may be calculated as the ratio of unknown word character strings with respect to the total number of characters. Alternatively, the following method may be used as a simplest method. For example, statistical data for respective standard Japanese characters are prepared in advance, and similar statistical data is also generated based on a scanned document. If this data is largely different from that of standard Japanese text, it is determined that the document is abnormal, and the reliability of the character recognition result is low. With this arrangement, a language analysis process that imposes a heavy load on the computer can be avoided, and a statistical process with a lighter load can be executed instead. For this reason, the reliability of character recognition can be evaluated even in a poor computer environment, and a master copy search can be implemented with lower cost.

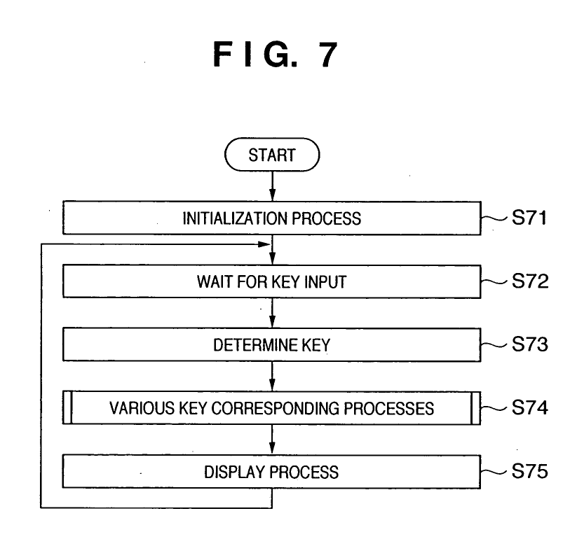

The aforementioned operation will be described below with reference to the flowchart. FIG. 7 is a flowchart showing the processing sequence of the operation of the document search apparatus according to this embodiment, i.e., that of the CPU 101.

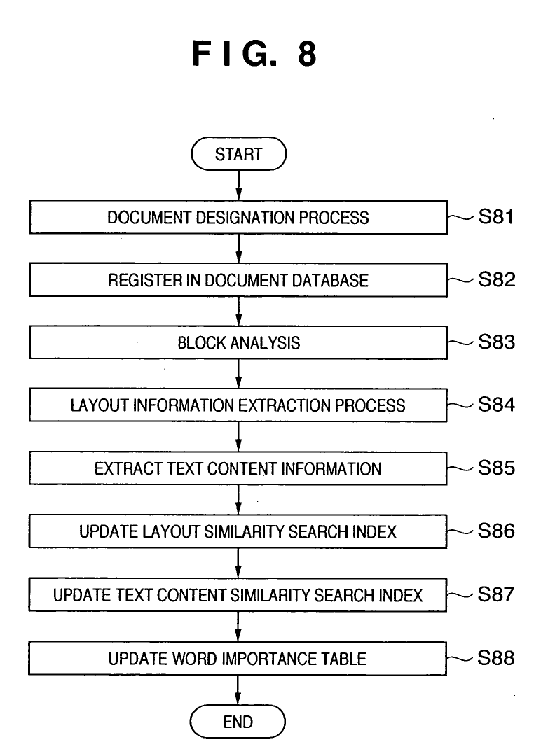

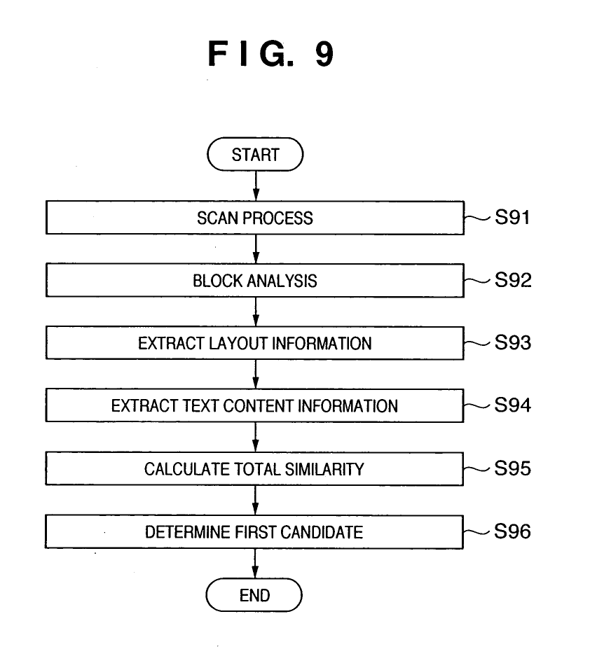

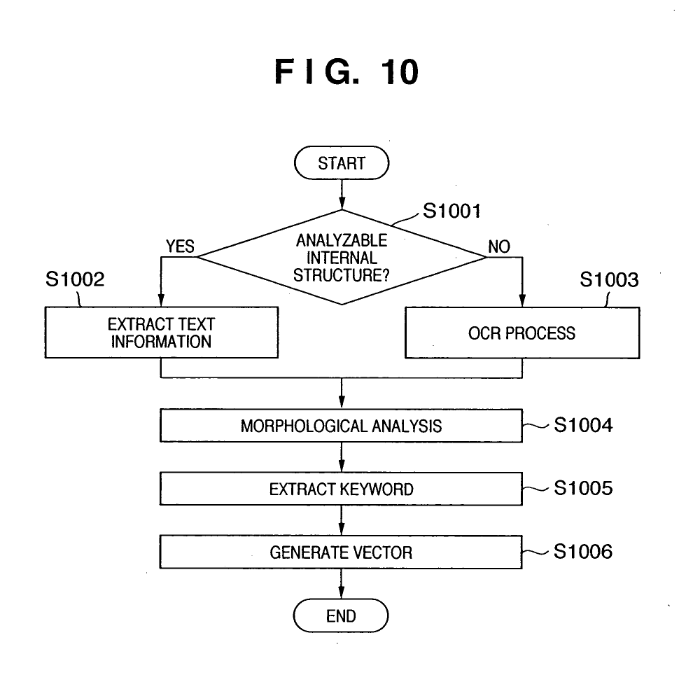

In step S71, a system initialization process is executed, i.e., various parameters are initialized, an initial window is displayed, and so forth. In step S72, the CPU 101 waits for an interrupt generated upon depression of an arbitrary key on the input device such as a keyboard or the like. If the user has pressed a key, the microprocessor CPU discriminates this key in step S73, and the control branches to various processes according to the type of key. A plurality of processes as branch destinations corresponding to respective keys are described together in step S74. A document registration process and master copy search execution process which will be described using FIGS. 8 and 9 correspond to some of these branch destinations. Other processes include a process for conducting a search by inputting a query character string from the keyboard, a process for document management such as version management or the like, and so forth (a detailed description of these processes will be omitted in this specification). In step S75, a display process for displaying the processing results of respective processes is executed. The display process is a prevalent process, i.e., the display contents are rasterized to a display pattern, and the display pattern is output to a buffer.

FIG. 8 is a flowchart showing details of the document registration process as one process in step S74. In step S81, the control prompts the user to designate a document to be registered in the document database. The user designates digital document data present on a disk or a paper document. In step S82, the designated document to be registered is registered in the document database. If a paper document is designated, the paper document to be registered is scanned as digital data by the scanner 106 to generate a bitmap image, which is registered. In step S83, the bitmap image undergoes block analysis, and is separated into a text block, image block, and the like. In step S84, layout information is extracted from the registered document. If the registered document is data created using a wordprocessor or the like, a bitmap image is generated by executing a pseudo print process, and the processes in steps S83 and S84 use this bitmap image.

In step S85, as will be described in detail later using FIG. 9, text information is extracted from the registered document (in case of the paper document, OCR text is extracted from a text block). In case of OCR text extraction, false recognition characters are removed from the extracted text, and a document vector is generated as text content information. In step S86, the layout information extracted in step S84 is registered in the layout similarity search index (FIG. 4) in correspondence with its document ID to update the index contents. In step S87, the text content information extracted in step S85 is registered in the text content similarity search index (FIG. 5) in correspondence with its document ID to update that index contents. In step S88, the frequencies of occurrence of words included in the registered document are added to the word importance table (FIG. 6) to update the table contents.

FIG. 9 is a flowchart showing details of the master copy search execution process as one process in step S74.

In step S91, a paper document as a query of a master copy search is scanned by the scanner 106 to generate a bitmap image. In step S92, the scanned bitmap image undergoes block analysis to be separated into a text block, image block, and the like. In step S93, layout information such as an image feature amount and the like is extracted from the bitmap image. In step S94, OCR text information is extracted from the text block by a character recognition process, and false recognition characters are removed by extracting words from the extracted text with reference to the keyword dictionary 116, thus generating a query vector as text content information. In step S95, text content similarity levels between the query vector and respective document vectors of the documents registered in the document database are calculated, and layout similarity levels are also calculated for respective documents, thus calculating total similarity levels. In step S96, the order is settled in accordance with the total similarity level, and the first candidate is determined and output.

FIG. 10 is a flowchart showing details of the text content information extraction in steps S85 and S94. It is checked in step S1001 if text information can be extracted by analyzing a file format. If text information can be extracted, the flow advances to step S1002, and text information is extracted by tracing the file format of the document. After that, the flow advances to step S1004. If text information cannot be extracted by analyzing a file format due to a bitmap image or the like, the flow advances to step S1003. In step S1003, character recognition is applied to the bitmap image to extract OCR text information. After that, the flow advances to step S1004.

In step S1004, morphological analysis is applied to the extracted text to analyze the text. In step S1005, keywords registered in the keyboard dictionary 116 are extracted from the text information extracted in step S1002 or S1003 to generate extracted keyword data. Since only words which belong to specific parts of speech (noun, proper noun, and verbal noun) are registered in the keyword dictionary 116, only words of specific parts of speech are automatically extracted. A vector is generated and output based on the extracted keyword data in step S1007.

As described above, according to the first embodiment, a document vector is generated based on words registered in the keyword dictionary, and is used in a master copy search. Hence, the master copy search can be conducted while false recognition characters are deleted, and the search precision can be improved.

### Second Embodiment

Note that the present invention is not limited to the above embodiment, and various changes and modifications may be made without departing from the sprit and scope of the invention.

In the first embodiment described above, only words described in the keyword dictionary are extracted to remove false recognition characters. However, with this method, only a word list is extracted, and information such as the order among words and the like is lost. Hence, in the second embodiment, in place of extracting only keywords, text obtained by removing unknown words determined as a result of morphological analysis from the extracted text is used, and text information is preserved as much as possible.

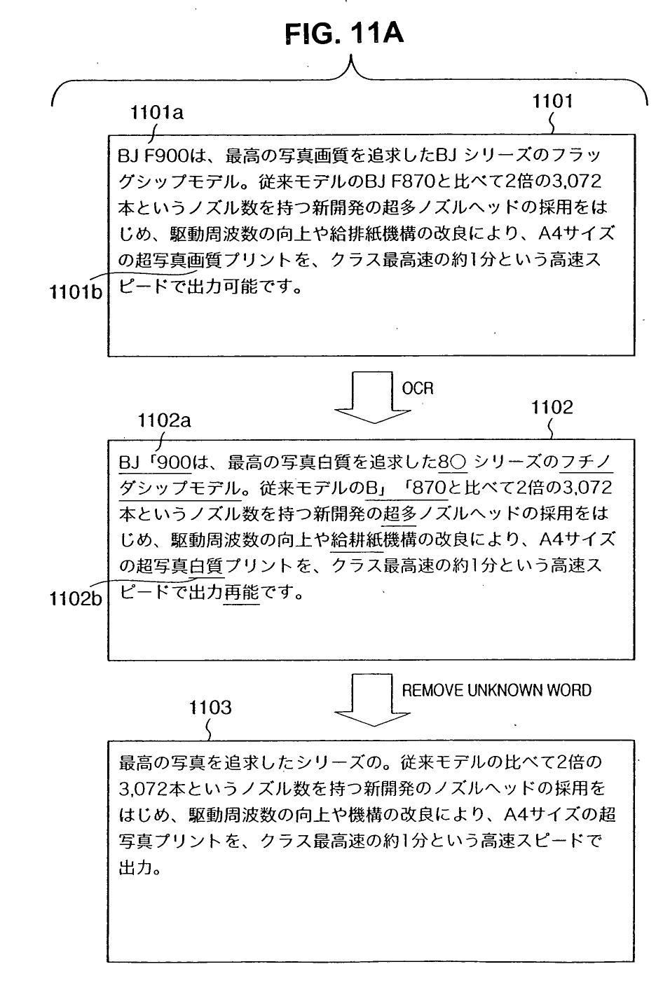

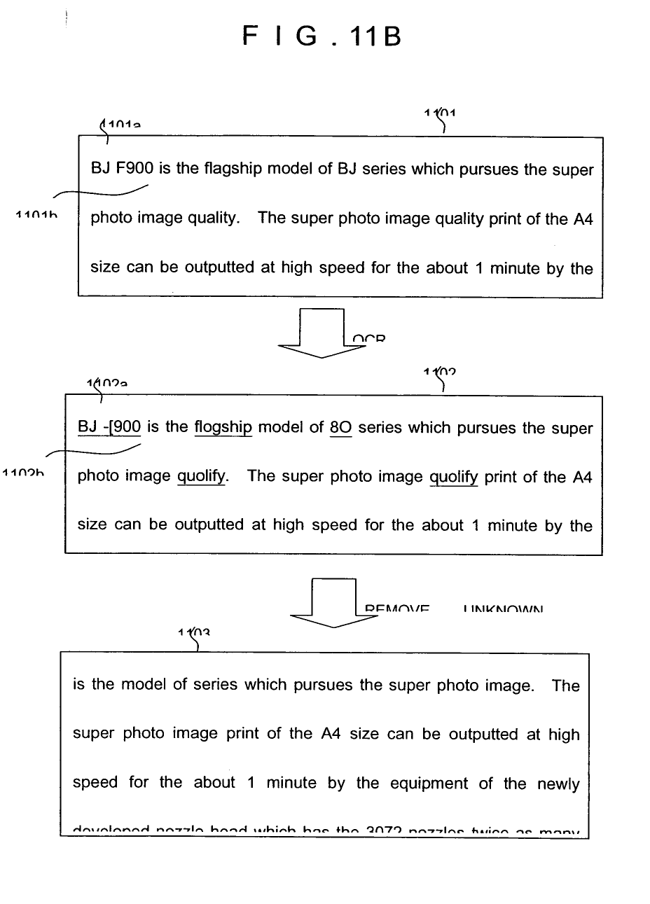

FIG. 11 shows an example of false recognition character removal according to the second embodiment. A text block 1101 and OCR text information 1102 are the same as those in the first embodiment (FIG. 3), but unknown word removal is adopted as a method of the last false recognition removal. For example, the text block of original text includes words “F900 (1102a)”, “ [symbol] (1102b)”, and the like, which appear as false recognition words in the OCR text information (1102a, 1102b). Since the words including false recognition are not registered in an analysis dictionary, they become unknown words, and are removed from the false recognition-removed text data. In FIG. 11, unknown words are underlined.

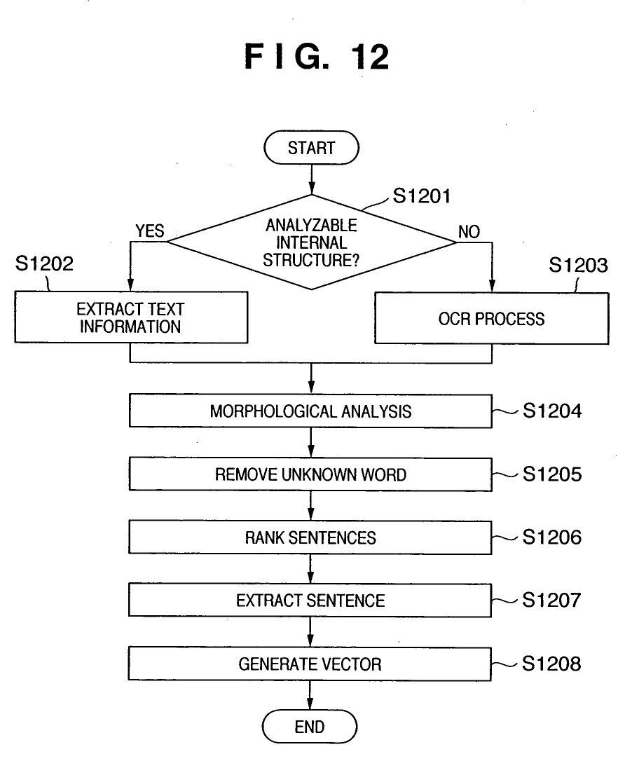

FIG. 12 is a flowchart showing the text content information extraction process of the second embodiment. FIG. 12 is a flowchart showing details of text content extraction in step S85 in FIG. 8 and step S94 in FIG. 9.

It is checked in step S1201 if text information can be extracted by analyzing a file format. If text information can be extracted, the flow advances to step S1202, and text information is extracted by tracing the file format of the document. After that, the flow advances to step S1204. If text information cannot be extracted by analyzing a file format due to a bitmap image or the like, the flow advances to step S1203. In step S1203, character recognition is applied to the bitmap image to extract OCR text information. After that, the flow advances to step S1204. In step S1204, morphological analysis is applied to the text extracted in step S1202 to analyze the text. In step S1205, unknown words which cannot be analyzed by morphological analysis are specified, and are removed from the text. In step S1206 and subsequent steps, the number of included words is counted to generate a vector on the basis of the text from which unknown words are removed, thus outputting the vector.

In the second embodiment, since similarity is calculated in consideration of the order of occurrence of words in addition to the frequencies of occurrence of words upon checking similarity, the processes in step S1206 and subsequent steps are executed as follows.

In step S1206, the frequencies of occurrence of words which are included in the text obtained in step S1205 and belong to specific parts of speech (noun, proper noun, and verbal noun) are calculated to rank these words using their importance levels. Furthermore, sentences are ranked in the order of those which include important words. In step S1207, sentences are extracted up to a predetermined size in the order of sentence rank determined in step S1206, and text feature data are generated and output based on the extracted sentences. The predetermined size can be varied at system's convenience, and a size (the number of sentences or the number of words included in a sentence) is set so as not to impose an excessive processing load upon executing a search.

In step S1208, the frequencies of occurrence of word pairs are counted based on the extracted sentences. In this word pair, the order of words is taken into consideration. For example, the text data 1103 in FIG. 11 includes a word pair “ [symbol] ” and “ [symbol] ” but no word pair “ [symbol] ” and “ [symbol] ”. By making the similarity calculation of equation (2) using such word pairs, similarity checking can be made in consideration of the order of occurrence of words.

Since the above process is applied to the text content information extraction process (step S85) upon registering a document in the database, each dimension of the document vectors in the text content similarity search index 114 includes word pairs. However, the importance levels of words may change upon updating the database contents due to a newly registered document, and important sentences may change. Hence, the contents of the text content similarity search index 114 must be periodically updated by periodically executing the above text content information extraction process for the registered documents.

With the arrangement of the second embodiment, since text feature data can be extracted while preserving original text information to some extent, a highly reliable master copy search can be implemented.

In the second embodiment, the similarity calculation may be made using the frequencies of occurrence of words as in the first embodiment within the range of extracted important sentence without using any word pairs. In this case, the order of words is not taken into consideration, but words which are to undergo similarity comparison can be effectively narrowed down.

### Third Embodiment

As a false recognition removal method, recognition assistance (spell corrector in English) may be applied to OCR text. The methods described so far merely remove portions which may include errors, and if the number of false recognition characters is too large, the number of unextracted words or removed words becomes too large, thus deteriorating the search precision. Hence, in the third embodiment, false recognition characters are not only removed but also positively corrected to prevent the search precision from deteriorating.

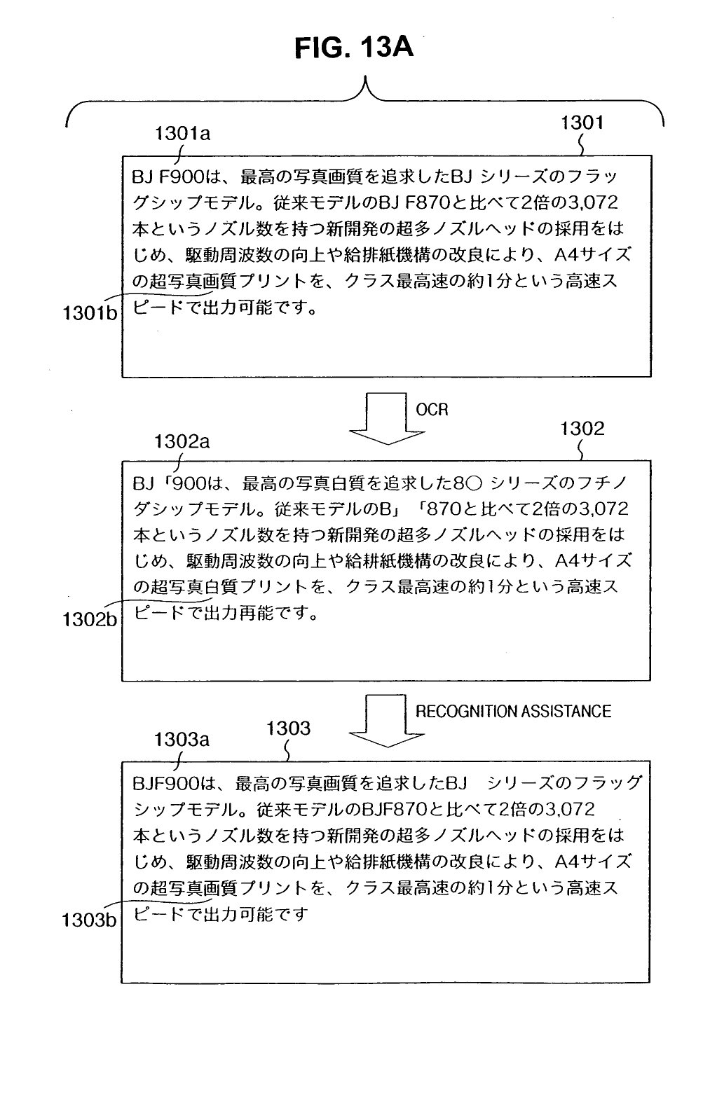

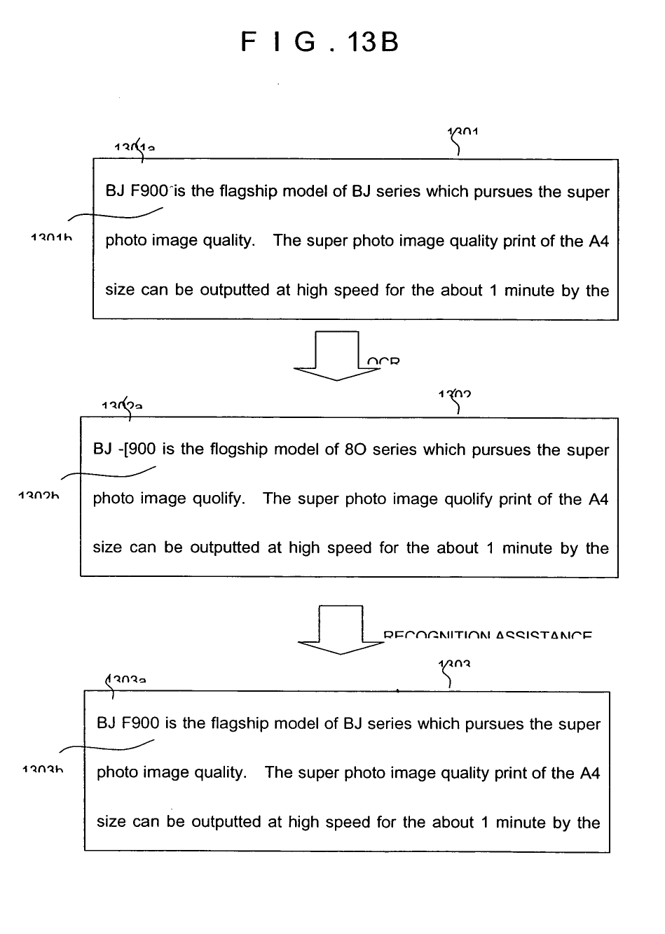

FIG. 13 shows an example of false recognition removal in the third embodiment. A text block 1301 and OCR text information 1302 are the same as those in the first and second embodiments, but recognition assistance is adopted as a method of the last false recognition removal. Note that word correction in recognition assistance can adopt a method disclosed in, e.g., Japanese Patent Laid-Open No. 2-118785.

For example, the text block 1301 of the original text includes words “F900 (1301a)”, “ [symbol] (1301b)”, and the like, which appear as false recognition words“┌900 (1302a)”, “ [symbol] (1302b)”, and the like in the OCR text information 1302. Recognition assistance is applied to such OCR text. For example, if such words are compared with a recognition assistance dictionary which is registered with correct words, and a certain level of match is detected, a process for correcting these words to registered-words is applied to correct the words to “F900 (1303a)” and “ [symbol] (1303b)”. Note that “ [symbol] ” is a normal word and can be easily registered in the recognition assistance dictionary. However, since “F900” is a special word for that user, it cannot be expected to be registered in a general recognition assistance dictionary. Such words are supported by preparing a dictionary (so-called user dictionary) in which the user can individually register such words. With the above arrangement, since false recognition words can be removed while preserving the original text size even when false recognition words are generated, a highly reliable master copy search can be implemented.

Note that the word correction process of the morphological analysis result according to the third embodiment can be applied to both the first and second embodiments.

### Fourth Embodiment

Furthermore, a method of removing false recognition characters for respective characters using recognition likelihood upon character recognition may be used as the false recognition removal method. In the first to third embodiments, portions which may include false recognition are removed or corrected for respective words. In such case, a process for respective words must be done, and a natural language analysis process such as morphological analysis or the like is included, resulting in a heavy processing load. Hence, false recognition is removed for respective characters, and OCR recognition likelihood is used as a basis of removal. OCR detects the possibility of false recognition with respect to false recognition characters to some extent, and quantitatively outputs this false recognition possibility as an OCR likelihood. Hence, characters whose OCR likelihood values do not reach a certain level are determined as false recognition characters, and are uniformly removed. At the same time, since the similarity checking reference is changed from word basis to character basis, morphological analysis is removed from the processing flow, thus reducing the processing load on the system.

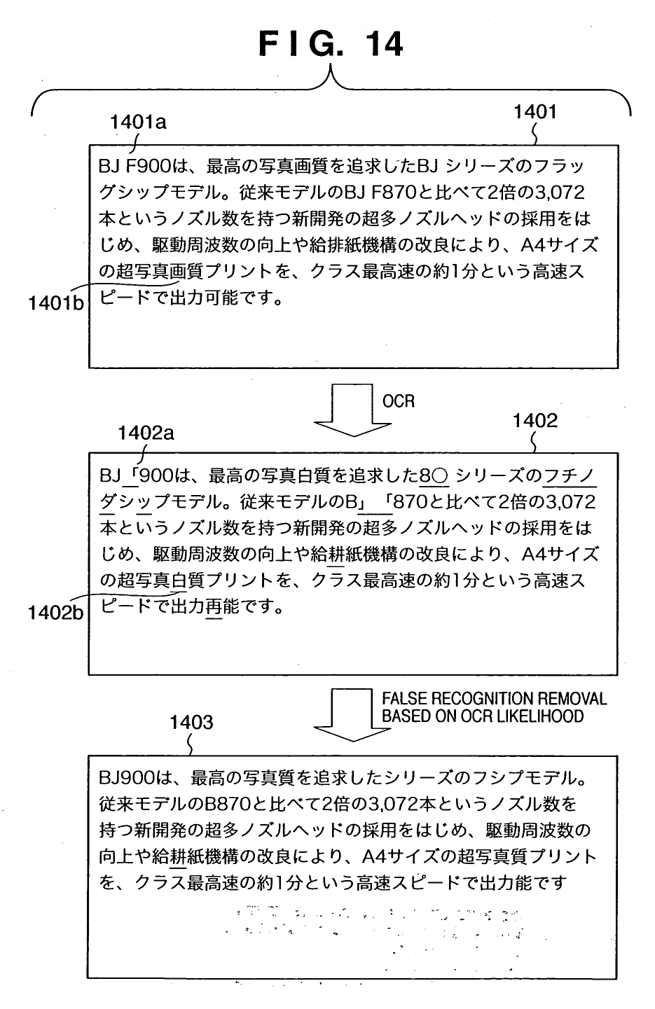

FIG. 14 shows an example of false recognition removal in the fourth embodiment. A text block 1401 and OCR text information 1402 are the same as those in the first to third embodiments above, but false recognition character removal based on OCR likelihood is adopted as a method of the last false recognition removal. For example, a text block 1401 of the original text includes words “F900 (1401a)”, “ [symbol] (1401b)”, and the like, which appear as false recognition words “┌900 (1402a)”, “ [symbol] (1402b)”, and the like in the OCR text information 1402. Since the OCR likelihood values for “┌” and “ [symbol] ” are not so high, these characters can be removed, and false recognition-removed text data from which only (potential) false recognition characters are removed is generated. Note that characters with low OCR likelihood values in the OCR text information 1402 in FIG. 14 are underlined.

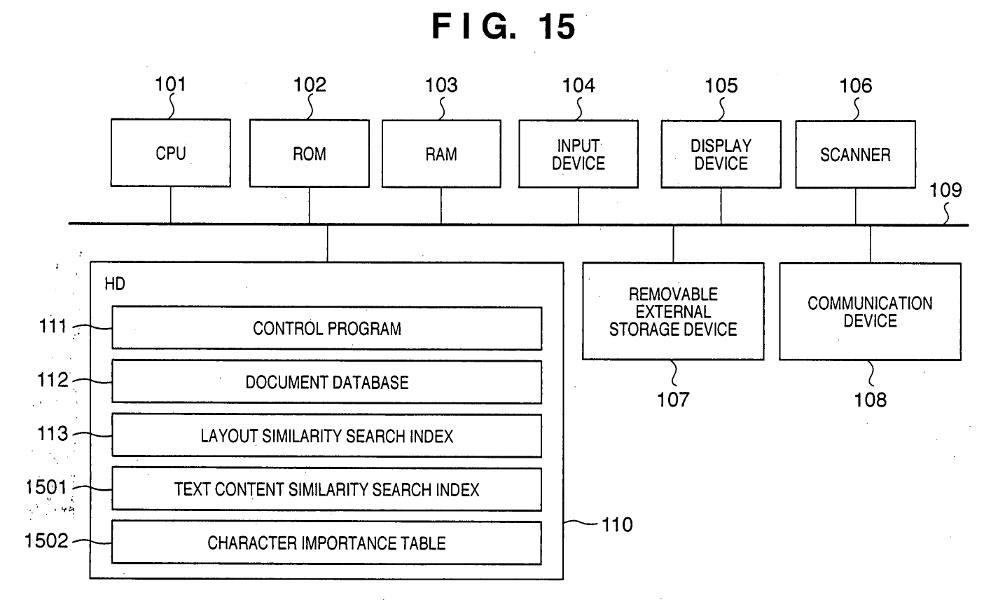

Differences from the first embodiment in the system of the fourth embodiment will be described below with reference to FIGS. 15 to 18.

FIG. 15 is a block diagram showing the arrangement of a system according to the fourth embodiment. A character importance table 1502 is held in place of the word importance table 115 in the arrangement shown in FIG. 1. Also, each document vector in a text content similarity search index 1501 is defined by a table that includes characters as dimensions.

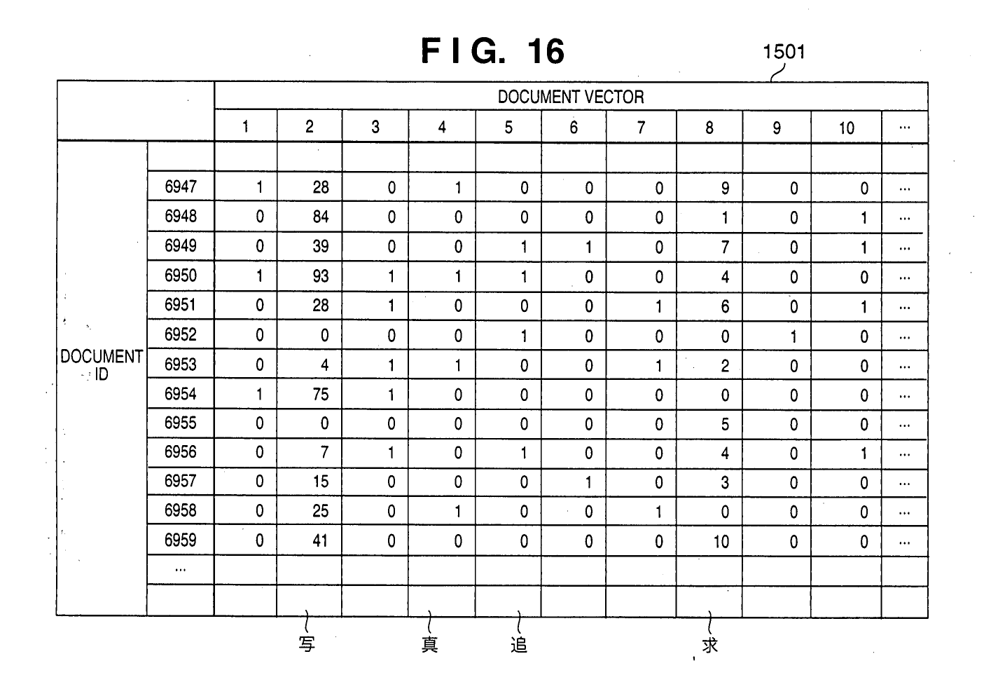

FIG. 16 shows the configuration of the text content similarity search index 1501 according to the fourth embodiment. The text content similarity search index 114 in FIG. 5 forms a document vector using words as dimensions. By contrast, the text content similarity search index 1501 in FIG. 16 forms a vector using characters as dimensions. For example, in FIG. 16, “ [symbol] ” corresponds to dimension 2, “ [symbol] ”, corresponds to dimension 4, “ [symbol] ” corresponds to dimension 5, and “ [symbol] ” corresponds to dimension 8. The frequencies of occurrence of respective characters included in a document of interest are stored.

The character importance table 1502 indicating the importance levels of respective characters upon checking text content similarity has a configuration similar to the word importance table shown in FIG. 6.

Note that the table in FIG. 6 stores the frequencies of occurrence for respective words, while the character importance table 1502 stores those for respective characters. That is, this character importance table 1502 stores the frequencies of occurrence of characters with respect to the whole document database.

Also, the similarity calculations upon checking the similarity of documents are made using equations (1) and (2) above. In these equations (1) and (2), wk represents the importance level of character k in place of that of word k, and respective elements of document vector X (X=(x₁, x₂, X₃, . . . , xₙ)) and query vector Q (Q=(q₁, q₂, q₃, . . . , qₙ, )) represent the frequencies of occurrence of characters.

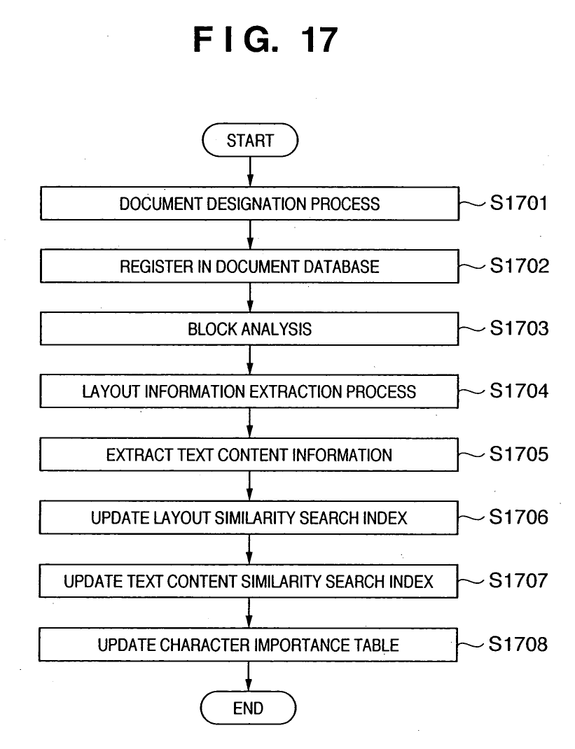

FIG. 17 is a flowchart showing details of the document registration process as one process in step S74. Steps S1701 to S1707 are the same as steps S81 to S87 in FIG. 8. In step S1708, the frequencies of occurrence of characters included in the document to be registered are added to the character importance table to update the table contents. Note that the master copy search process is the same as that shown in the flowchart of FIG. 9.

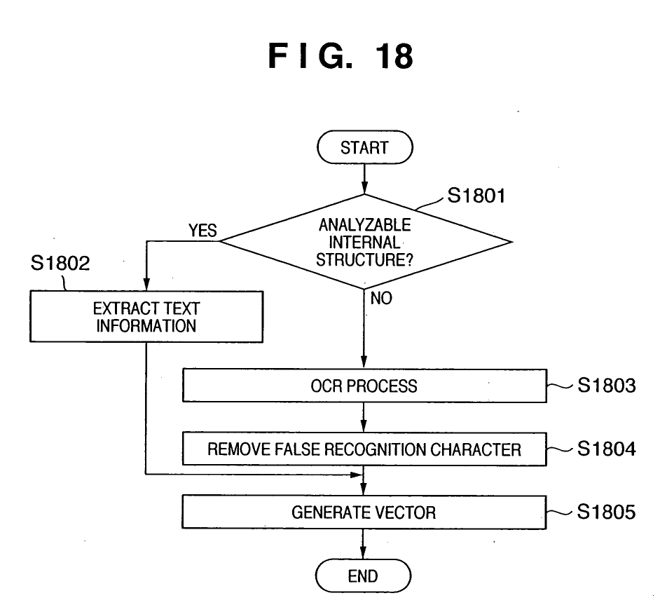

FIG. 18 is a flowchart showing details of the document content information extraction in steps S1705 and S94. It is checked in step S1801 if text information can be extracted by analyzing a file format. If text information can be extracted, the flow advances to step S1802, and text information is extracted by tracing the file format of the document. After that, the flow advances to step S1805. If text information cannot be extracted by analyzing a file format due to a bitmap image or the like, the flow advances to step S1803. In step S1803, character recognition is applied to the bitmap image to extract OCR text information. After that, the flow advances to step S1804. In step S1804, characters whose OCR likelihood values do not reach a given level are determined as false recognition characters, and are removed from text. In step S1805, the number of characters included in the text is counted on the basis of the text obtained in step S1802 or the OCR text from which the false recognition characters are removed in step S1804 to generate a vector, and that vector is output.

With the above arrangement, since false recognition characters can be removed without morphological analysis, a highly reliable master copy search with a light processing load can be implemented.

Note that the objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a flexible disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

As can be seen from the above description, according to the present invention, the need for troublesome processes such as search range designation and the like can be obviated, and a master copy search with high precision can be implemented within a practical response time.

As many apparently widely different embodiments of the present invention can be made without departing from the spirit and scope thereof it is to be understood that the invention is not limited to the specific embodiments thereof except as defined in the appended claims.

What is claimed is:

1. A document search method for searching for a document, comprising:
a character recognition step of executing a character recognition process for an image of a search document;
an extraction step of extracting text data which is estimated to be correctly recognized from text data obtained in the character recognition step; .
a generation step of generating text feature information on the basis of the text data extracted in the extraction step; and
a search step of searching a plurality of documents for a document corresponding to the search document using the text feature information generated in the generation step as a query.

2. The method according to claim 1, wherein the extraction step includes a step of extracting words of predetermined parts of speech by analyzing the text data obtained in the character recognition step, and extracting words which are registered in a predetermined dictionary of the extracted words as the text data which is estimated to be correctly recognized.

3. The method according to claim 2, wherein the generation step includes a step of generating the text feature information on the basis of frequencies of occurrence of words included in the text data extracted in the extraction step.

4. The method according to claim 3, wherein the generation step includes a step of extracting a sentence of a predetermined size from the text data extracted in the extraction step on the basis of importance levels of words included in the extracted text data, the importance level being determined based on the frequency of occurrence of a word in the plurality of documents, and generating the text feature information on the basis of the frequencies of occurrence of words included in the extracted sentence.

5. The method according to claim 2, wherein the generation step includes a step of generating the text feature information on the basis of the frequency of occurrence of respective word groups in consideration of an order of occurrence of respective words included in the extracted sentence.

6. The method according to claim 2, wherein the extraction step includes a process for correcting a word which is included in the text data obtained in the character recognition step and is estimated to be a false recognition word to a known word, and adding the corrected word to correctly recognized text data.

7. The method according to claim 1, wherein the extraction step includes a step of extracting characters whose recognition likelihood values, which are provided by the character recognition step, exceed a predetermined threshold value as the text data which is estimated to be correctly recognized.

8. The method according to claim 7, wherein the generation step includes a step of generating the text feature information on the basis of frequencies of occurrence of characters included in the text data extracted in the extraction step.

9. A document search apparatus for searching for a document, comprising:
a character recognition unit configured to execute a character recognition process for an image of a search document;
an extraction unit configured to extract text data which is estimated to be correctly recognized from text data obtained b said character recognition unit;
a generation unit configured to generate text feature information on the basis of the text data extracted by said extraction unit; and
a search unit configured to search a plurality of documents for a document corresponding to the search document using the text feature information generated by said generation unit as a query.

10. The apparatus according to claim 9, wherein said extraction unit extracts words of predetermined parts of speech by analyzing the text data obtained by said character recognition unit, and extracts words which are registered in a predetermined dictionary of the extracted words as the text data which is estimated to be correctly recognized.

11. The apparatus according to claim 10, wherein said generation unit generates the text feature information on the basis of frequencies of occurrence of words included in the text data extracted by said extraction unit.

12. The apparatus according to claim 11, wherein said generation unit extracts a sentence of a predetermined size from the text data extracted by said extraction unit on the basis of importance levels of words included in the extracted text data, the importance level being determined based on the frequency of occurrence of a word in the plurality of documents, and generating the text feature information on the basis of the frequencies of occurrence of words included in the extracted sentence.

13. The apparatus according to claim 10, wherein said generation unit generates the text feature information on the basis of the frequency of occurrence of respective word groups in consideration of an order of occurrence of respective words included in the extracted sentence.

14. The apparatus according to claim 10, wherein said extraction unit corrects a word which is included in the text data obtained by said character recognition unit and is estimated to be a false recognition word to a known word, and adding the corrected word to correctly recognized text data.

15. The apparatus according to claim 9, wherein said extraction unit extracts characters whose recognition likelihood values, which are provided by said character recognition unit, exceed a predetermined threshold value as the text data which is estimated to be correctly recognized.

16. The apparatus according to claim 15, wherein said generation unit generates the text feature information on the basis of frequencies of occurrence of characters included in the text data extracted by said extraction unit.

17. A control program for making a computer execute a document search method of claim 1.

18. A computer readable memory storing a control program for making a computer execute a document search method of claim 1.
